(19) United States
(12) Patent Application Publication
(10) Pub. No.: US 2015/0338165 A1
(43) Pub. Date: Nov. 26, 2015

(54) UNIFORM-HEAT GRAIN DRYER WITH BYPASS MOISTURE TESTER

(71) Applicant: CHIA WEI LIN, Yilan County (TW)

(72) Inventor: CHIA WEI LIN, Yilan County (TW)

(21) Appl. No.: 14/287,119

(22) Filed: May 26, 2014

(51) Int. Cl. F26B 17/12; F26B 25/00

(52) U.S. Cl. CPC F26B 17/12; F26B 25/001

(57) ABSTRACT

A uniform-heat grain dryer with bypass moisture tester comprises a dryer section, a bypass moisture test section, an impurity separating section and an impurity collection section; the dryer section has multi-stage drying units with hot air outlets to blow out hot air in a direction opposite to each other; the bypass moisture test section is positioned outside the dryer section to take a small amount of sample grains to reduce the interferences of the environment factors; the impurity separating section has a separating drum to separate the grains from the impurities such as husks; the impurity collecting section collects the impurities to avoid scattering everywhere and keep the work environment clean. Due to multi-stage drying alternately, the wet grains are heated uniformly till fully dried to overcome the deficiency of one side being overheated or scorched. The bypass moisture tester arranged at the outer side of the dryer section enhances the life span thereof in addition to reducing interferences of the environment factors.

### BACKGROUND OF THE INVENTION

1. Field of the Invention

The present invention relates to a uniform-heat grain dryer with bypass moisture tester, and particularly to a grain dryer having multi-stage hot air outlets with which hot air blown via each of the hot air outlets is in a direction opposite to each other to dry the grains alternately, a moisture tester with which a small amount of grains is taken as tested samples to lower interference caused by the environment factor and enhance accuracy of the test, an impurity separating section with which the dried grains are separated from the impurities, and an impurity collecting section with which the impurities are gathered together to avoid polluting the environment such that the grains are dried, tested, separated, and collected consistently to enhance the processing efficiency.

2. Brief Description of Prior Art

The traditional way to dry wet grains employs a grain drying equipment to conduct the drying operation. The conventional grain drying equipment illustrated in FIG. 1 has a drying chamber 90, and a grain spreading device 98 on top of the drying chamber 90; the wet grains are poured into the drying equipment via the top of the drying chamber 90. The drying chamber 90 is provided with a hot air outlet (not shown), and hot air is blown out via the hot air outlet to dry the wet grains. However, the hot air is blown along a single direction, and each of the wet grains is dried at one side only to result in the grains have an overheated and scorched side and not fully dried other sides respectively. The preceding deficiency leads to poor quality for the dried grains and selling prices thereof being unable to increase advantageously.

To determine if the grains have reached an extent of required dryness usually needs an aid of a moisture tester. Currently, an online moisture tester 95 shown in FIG. 1 is often used, that is, a percentage of moisture containing in the respective grain is tested in the drying process. The online moisture tester 95 is usually mounted on the lateral wall of the drying chamber 90. When the grains pass by the online moisture tester 95 and contact the testing surface of the online moisture tester 95, the percentage of moisture can be measured. However, in order to acquire the percentage of moisture accurately, environment factors such as density, uniform distribution, flow speed, and mixed impurities have to be coordinated steadily during the online moisture tester 95 in operation. If the environment factors are unable to coordinate with the online moisture tester 95 steadily, it is not possible to obtain accurate data with respect to the percentage of moisture in the grains. According to the traditional way, the moisture tester 95 is installed on the lateral wall of the drying chamber 90, and there is a considerable space in the drying chamber 90. Hence, the moisture tester is easily interfered by the grains moving in the drying chamber 90 irregularly and randomly with rapid fluctuations of the environment factors, and it is often that the moisture tester emerges discrepant test data. Under the circumferences, it is misunderstood that the moisture tester is out of order and the usual solution is to replace the moisture tester. But, the same problem with the discrepant test data occurs again soon after the replacement of the moisture tester. This is a trouble issue keeps perplexing the user greatly. Besides, a large amount of the grains poured down from the top of drying chamber 90 impacts the testing surface 96 of the moisture tester 95 unceasingly to cause the testing surface 96 being eroded and damaged easily. The phenomenon leads to incorrect test data as well. Accordingly, the arrangement of the moisture tester in the conventional grain dryer brings about a situation that the moisture tester has to be replaced or repaired frequently.

Furthermore, the wet grains, which usually mix with dried trigs and dried leaves, are poured into the drying chamber 90 from top, and husks detached from the dried grains mix with the dried grains as well. The dried trigs, dried leaves and the husks are impurities and have to be separated from the dried grains with a separating device. Because the separating process is performed individually, the investment for the separating device is needed in spite of the operational efficiency for the entire dryer being low. Especially, the husks are easy to adhere to the grains and hard to be separated from the grains, a great deal of additional investment for equipment to remove the husks effectively is also needed in order to overcome the problem of the husks keeping with the grains.

### SUMMARY OF THE INVENTION

The primary object of the present invention is to provide a uniform-heat grain dryer with bypass moisture tester with which multi-stage drying way is conducted in the drying chamber alternately to dry the wet grains uniformly so as to enhance drying quality.

The second object of the present invention is to provide a uniform-heat grain dryer with bypass moisture tester with which a bypass moisture test section is disposed to keep environment factors in the bypass test section steady such that the moisture tester is capable of offering accurate test data without being interfered.

The third object of the present invention is to provide a uniform-heat grain dryer with bypass moisture tester with which wear rate of the moisture tester is low to enhance life span thereof.

The fourth object of the present invention is to provide a uniform-heat grain dryer with bypass moisture tester with which a thin layer effect is generated to separate the dried grains from the impurities quickly to enhance efficiency.

The fifth object of the present invention is to provide a uniform-heat grain dryer with bypass moisture tester with which the impurities apart from the dried grains are gathered with sedimentary collection simply after the grains being dried so as to avoid environment pollution.

The sixth object of the present invention is to provide a uniform-heat grain dryer with bypass moisture tester with which the grains are treated consistently with uniform dry, bypass test, and centralized collection to enhance operational efficiency of the dryer.

### BRIEF DESCRIPTION OF THE DRAWINGS

The detail structure, the applied principle, the function and the effectiveness of the present invention can be fully understood with reference to the following description and accompanying drawings, in which:

FIG. 1 is a sectional view of the conventional grain dryer;

FIG. 2 is a sectional view of the first embodiment of a uniform-heat grain dryer with bypass moisture tester according to the present invention;

FIG. 3 is a perspective view of a separating drum in the uniform-heat grain dryer with bypass moisture tester according to the present invention illustrating the thin layer separation effect;

FIG. 4 is a perspective view of the impurity collecting section in the uniform-heat grain dryer with bypass moisture tester according to the present invention;

FIG. 5 is a sectional view similar to FIG. 2 illustrating the uniform-heat grain dryer with bypass moisture tester in operation;

FIG. 6 is a sectional view of the second embodiment of a uniform-heat grain dryer with bypass moisture tester according to the present invention;

FIG. 7 is sectional view of the third embodiment of a uniform-heat grain dryer with bypass moisture tester according to the present invention.

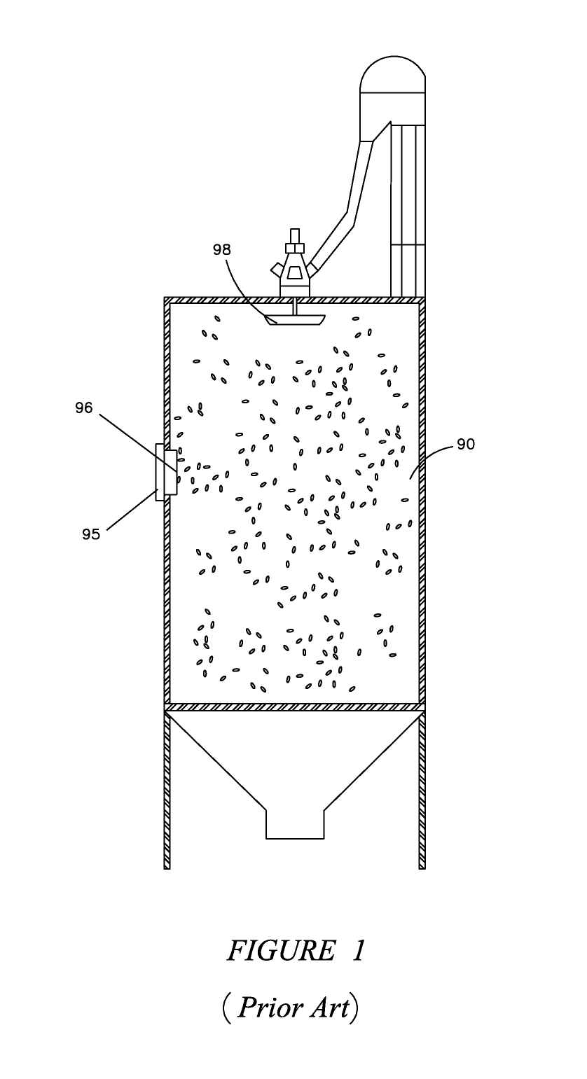

### DETAILED DESCRIPTION OF THE PRESENT INVENTION

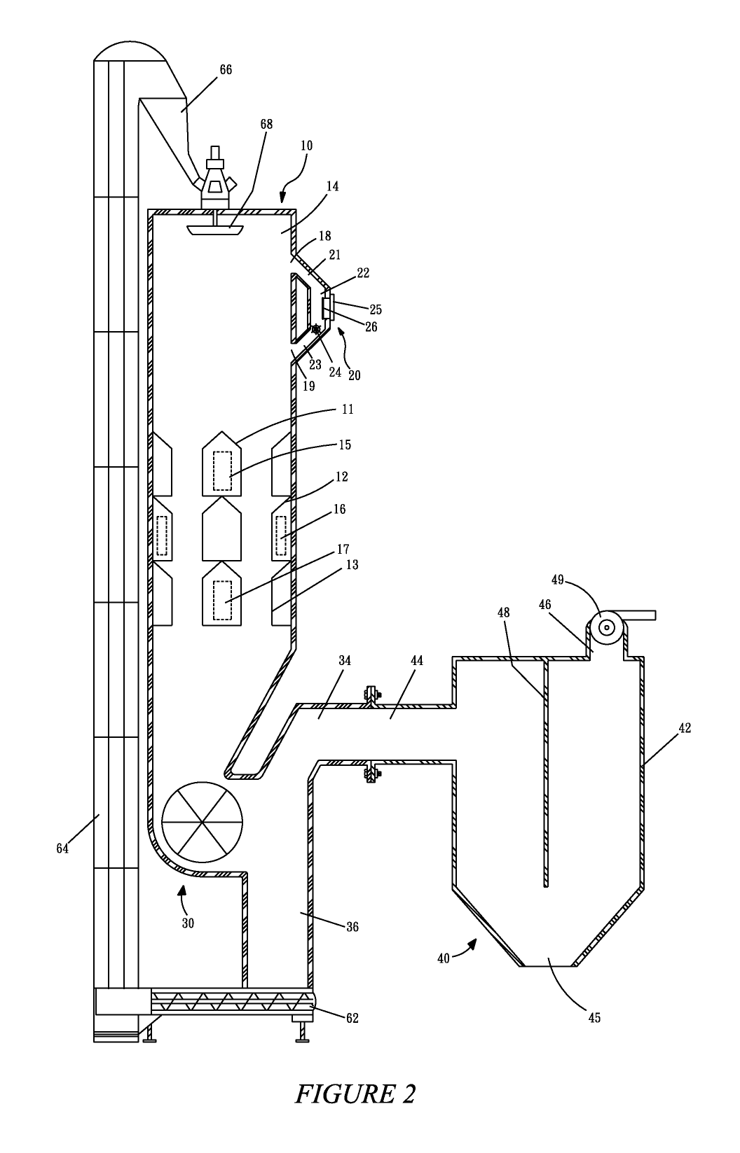

Referring to FIG. 2, the first embodiment of a uniform-heat grain dryer with bypass moisture tester according to the present invention is illustrated. The uniform-heat grain dryer with bypass moisture tester comprises a dryer section 10, a bypass moisture test section 20, and an impurity separating section 30. The dryer section 10 has a drying chamber 14 inside to receive and dry wet grains. The drying chamber 14 is installed with a plurality of drying units; there are a first drying unit 11, a second drying unit 12, and a third drying unit 13 shown in FIG. 2 for exemplary explanation only, and it is not to limit the number of the drying units. A first hot air outlet 15, a second hot air outlet 16, and a third hot air outlet 17 are disposed at the first drying unit 11, the second drying unit 12, and the third drying unit 13 respectively. For instance, the first hot air outlet 15 is provided at a preset position in the first drying unit 11, the second hot air outlet 16 is provided at a preset position in the second drying unit 12, and the third hot air outlet 17 is provided at a preset position in the third drying unit 13. Hot air from a hot air source (not shown) is blown outward via the first, second, and third hot air outlets 15, 16, and 17 such that the wet grains are dried while passing by the hot air outlets 15, 16, and 17. The hot air blown via the first hot air outlet 15 moves forward to a direction opposite to that blown via the second hot air outlet 16; the hot air blown via the second hot air outlet 16 moves forward to a direction opposite to that blown via the third hot air outlet 17, and so on. For example, if the hot air blown via the first hot air outlet 15 is from a center to sides, then the hot air blown via the second hot air outlet 16 is from the sides to the center, and the hot air blown via the third hot air outlet 17 is further from the center to the sides again. Therefore, when passing by the first drying unit 11, the wet grains are dried at one side thereof respectively by the hot air coming from the first hot air outlet 15; while continuing to pass by the second drying unit 12, the wet grains are dried at the other side thereof respectively by the hot air from the second hot air outlet 16; when passing by the third drying unit 13, the first dried side of the respective wet grain is dried again. This is a drying method similar to the Satay BBQ to uniformly heat both sides of each wet grain repeatedly to avoid a phenomenon of one of the sides being overheated and scorched. Hence, the dryer according to the present invention offers a multi-stage drying way alternately and repeatedly such that the wet grains are heated uniformly before being dried completely to overcome the deficiency of the conventional dryer device that only a single side of each of the wet grains is heated to result in the wet grains are either incomplete dried or over dried and scorched with poor quality. Furthermore, the drying units 11, 12, 13 are arranged in order to form a moving line for the wet grains being guided to travel along the moving line and dried sequentially.

The dryer section 10 has a first opening 18 and a second opening 19 located at two preset positions on the outer side thereof. The bypass moisture test section 20 comprises a feed conduit 21, a test conduit 22, a discharge conduit 23, a conveyer 24, and a moisture tester 25. An end of the feed conduit 21 is joined to the first opening 18 to communicate with the drying chamber 14, and another end of the feed conduit 21 connects with the test conduit 22. An end of the discharge conduit 23 is joined to the second opening 19 to communicate with the drying chamber 14, and another end of the discharge conduit 23 connects with the test conduit 22. Thus, sample grains 50 coming from the drying chamber 14 are capable of entering the bypass moisture test section 20 via the first opening 18 and leaving the bypass moisture test section 20 via the second opening 19 to the drying chamber 14 again. The conveyer 24, which is disposed at a preset position in the joint between the test conduit 22 and the discharge conduit 23, can be a conveying roller driven by a motor (not shown). After being tested by the moisture tester 25, the sample grains 50 are delivered to the drying chamber 14 by the conveyer 24 via the discharge conduit 23 and the second opening 19. The moisture tester 25 is disposed at a preset position of the test conduit 22. The sample grains 50 coming from the drying chamber 14 via the first opening 18 and the feed conduit 21 contact with and are tested by the moisture tester 25, then information with respect to the percentage of moisture in the respective sample grain 50 can be sent out; after being tested, the sample grains 50 are delivered back to the drying chamber 14 by the conveyer 24. Therefore, because there is only a small amount of the sample grains 50 is needed to contact with the moisture tester 25 in the bypass moisture test section 20, the test interfered by the environment factors is capable of being reduced with the environment factors being steady for the moisture tester 25 being capable of performing the test precisely, and data related to the moisture in the grains 50 can be obtained accurately. Meanwhile, because only a small amount of the sample grains 50 is admitted to pass the bypass moisture test section 20, it is avoidable that a testing surface 26 on the moisture tester 25 is impacted by a great deal of grains 50 to prevent the moisture tester 25 from wearing out soon and enhance the life span of the moisture tester 25. Besides, in order to intensify strength against wear, the testing surface 26 can be made of glass which provides good wear.

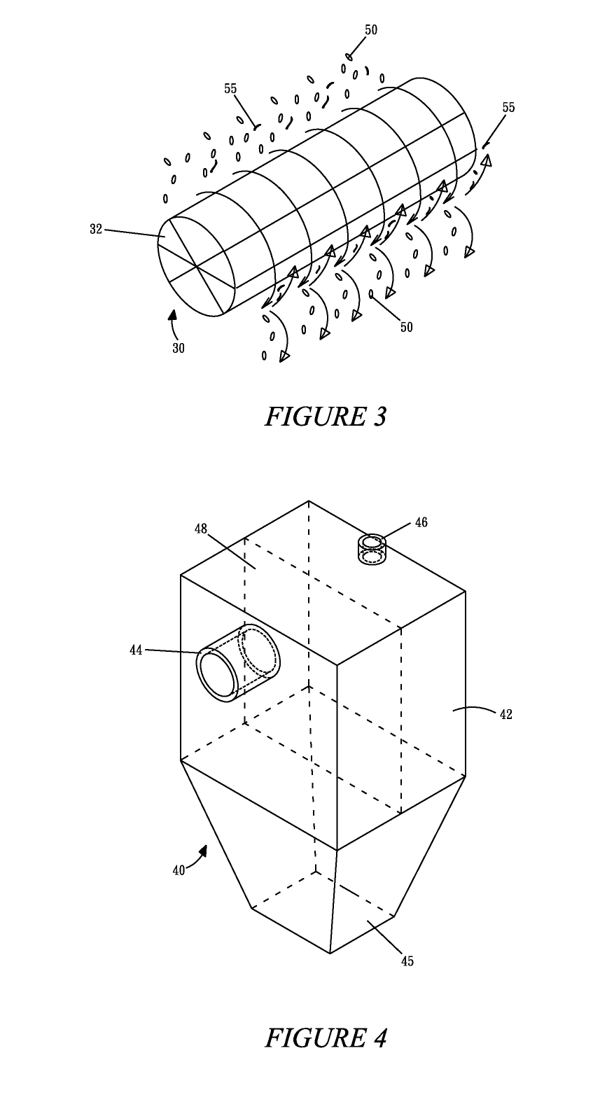

Referring to FIG. 2 and FIG. 3, the impurity separating section 30 has a separating drum 32 which is disposed at the bottom of the dryer section 10. When in operation, the separating drum 32 rotates clockwise to cause a centrifugal force; at the time of the dried grains 50 and the impurities 55 such as husks, straws, dried twigs, and dried leaves dropping on the separating drum 32, the dried grains 50 are slung downward, and the impurities 55, which are lighter than the dried grains 50, are slung upward as arrows indicated in FIG. 3. An impurity collection port 34 is disposed at a preset position above and near the separating drum 32, and the upward impurities 55 move outward via the impurity collection port 34 and are gathered with a collection device; a grain discharge port 36 is nearby the separating drum 32 and disposed at a preset position under the separating drum 32, and the grains 50 move outward via the grain discharge port 36 and are delivered to top of the dryer section 10 with a grain conveying device 62 and a lifting device 64 next to the dryer section 10 before reaching a grain spreading device 68 via a duct 66; the grains 50 are sprinkled downward from top of the drying chamber 14. The preceding process is operated repeatedly till the grains reach an extent of predetermined dryness before the grains can be taken out from the dryer. To decide if the grains have reached the predetermined dryness needs an aid of the moisture tester. Due to rotation of the separating drum 32 generating the thin layer effect, separation of the dried grains 55 from the impurities 55 such as husks, straws, dried twigs, and dried leaves becomes easily done. Especially, the husks are apt to keep covering the dried grains 50, and it is hard for the conventional drying way to separate the husks from the dried grains 50 in spite of the conventional drying equipment being costly. It is appreciated that the deficiency has been overcome with the uniform-heat grain dryer with bypass moisture tester according to the present invention. It is a great progress unable to be achieved with the conventional drying way.

Referring to FIGS. 2 and 4, the impurity collecting section 40 is disposed at the downstream of the impurity separating section 30; the impurity collecting section 40 has an impurity collecting barrel 42 with an impurity input pipe 44 at a lateral side thereof, an exhaust pipe 46 with an exhaust fan 49 at the top thereof, a baffle 48 therein, and a gradually converging lower part with an opening 45 at the bottom thereof. The impurity collecting section 40 is employed to collect the detached impurities 55 caused by the thin layer effect. The impurity input pipe 44 is connected to and engaged to a downstream exit of the impurity collection port 34 with fasteners. The centrifugal force of the separating drum 32 generates the thin layer effect to sling the heavy grains 50 downward and the light impurities 55 upward such that the grains 50 are discharged via the grain discharge port 36 and the impurities 55 are moved to the impurity collection port 34. Then, the impurities 55 are sucked by the exhaust fan 49 and keep moving forward till hitting the baffle 48; being blocked by the baffle 48, the impurities 55 fall down along the baffle 48 and pass through the opening 45 for being collected by the user. The baffle 48 has a preset length, and a clearance is formed between the bottom of the baffle 48 and the bottom of the impurity collecting barrel 42 to constitute an airflow path during the exhaust fan 49 running; that is, it is an effect of sedimentary collection, and the impurities are centralized and gathered to avoid scattering all over the place so as to keep the environment neat and clean.

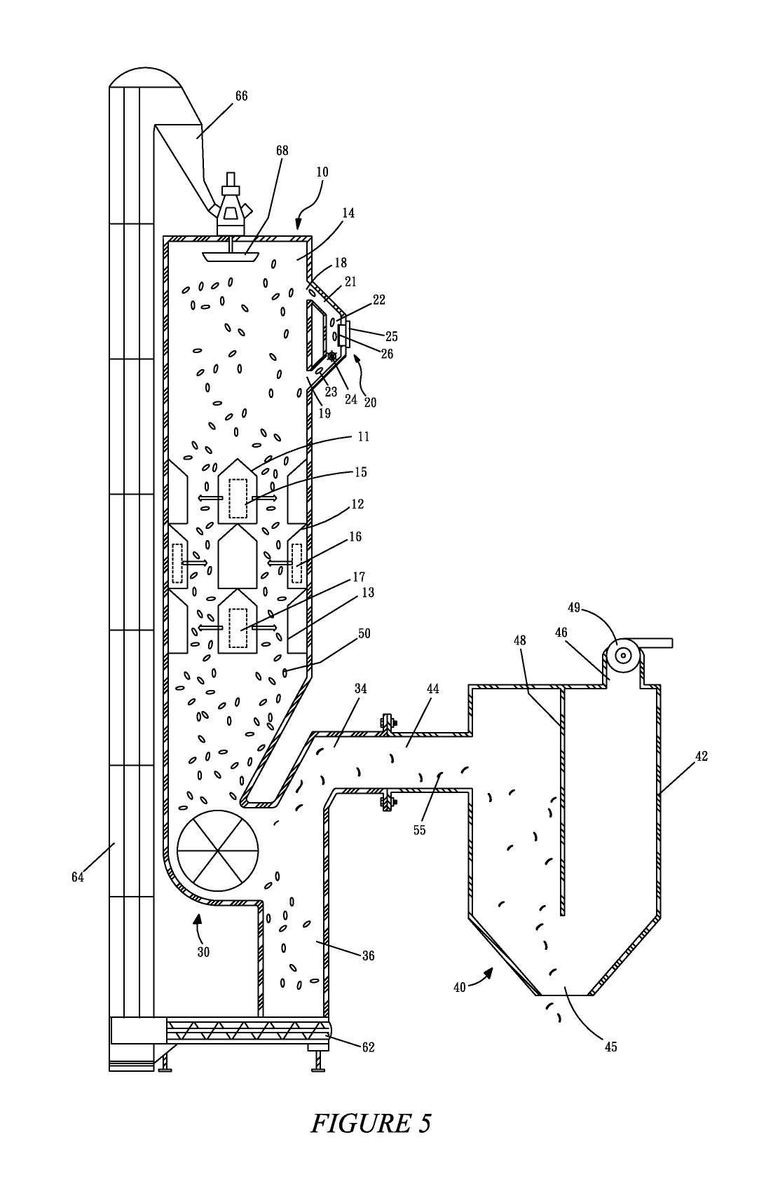

Referring to FIG. 5, the uniform-heat grain dryer with bypass moisture tester of the present invention in operation is illustrated. The wet grains 50 are poured into the dryer section 10 via the top thereof, guided by the grain drying units 11, 12, 13 to move forward, alternately dried by the hot air blown out via the respective first, second, and third hot air outlets 15, 16, 17 of the grain drying units 11, 12, 13 repeatedly; because the hot air is blown in a direction opposite to each other respectively, all sides of the grains 50 are heated uniformly till fully dried. Then, the dried grains 50 move to the impurity separating section 30 to be treated with the separating drum 32; due to the centrifugal force caused by rotation of the separating drum 32, the grains 50, which are heavier than the impurities 55, are slung downward, and the impurities 55 are slung upward resulting from the thin layer factor such that the grains 50 and the impurities 55 can be separated from each other. Finally, the impurities 55 are sucked by the exhausting fan 39 and move forward until hitting and being blocked by the baffle 48 before falling through the opening 45 along the baffle 48 to attain to the effect of sedimentary collection, and the impurities 55 passing through the opening 45 can be collected by the user to keep the environment neat and clean. The slung downward grains 50 discharging via the grain discharge port 36 are delivered to the grain scattering device 68 at the top of the dryer section 10 via the duct 66 with the grain conveying device 62 and a lifting device 64 next to the dryer section 10 and sprinkled downward from top of the drying chamber 14. The sprinkled grains 50 are capable of being taken as sample grains to enter the bypass moisture testing section 20 via the first opening 18 to contact with and be tested by the moisture tester 25 such that the information with respect to the percentage of moisture in the respective grains 50 can be sent out, and the sample grains 50 are moved back to the drying chamber 14 via the second opening 19. The preceding process is conducted to dry the grains 50 alternately with multiple stages of drying units. The information with respect to the percentage of moisture in the grains 50 being tested by the moisture tester 25 is a basis to determine if the grains reach the extent of the predetermined dryness. Hence, the grains 50 being dried alternately with multiple stages of drying units is an operation cycle which are performed repeatedly till the grains 50 reach the extent of predetermined dryness before the grains 50 can be taken out. Because only a small amount of the sample grains 50 is picked by the bypass moisture test section 20, the moisture tester 25 being interfered by the environment factors is reduced with the steady environment factors. Thus, the moisture tester 25 disposed in the bypass moisture test section 20 can perform the test precisely and obtain data related to the moisture in the grains 50 accurately. Meanwhile, because only a small amount of the sample grains 50 is admitted to pass the bypass moisture test section 20, it is avoidable that the testing surface 26 of the moisture tester 25 is impacted by a great deal of grains 50 to prevent the moisture tester 25 from wearing out soon and enhance the life span of the moisture tester 25.

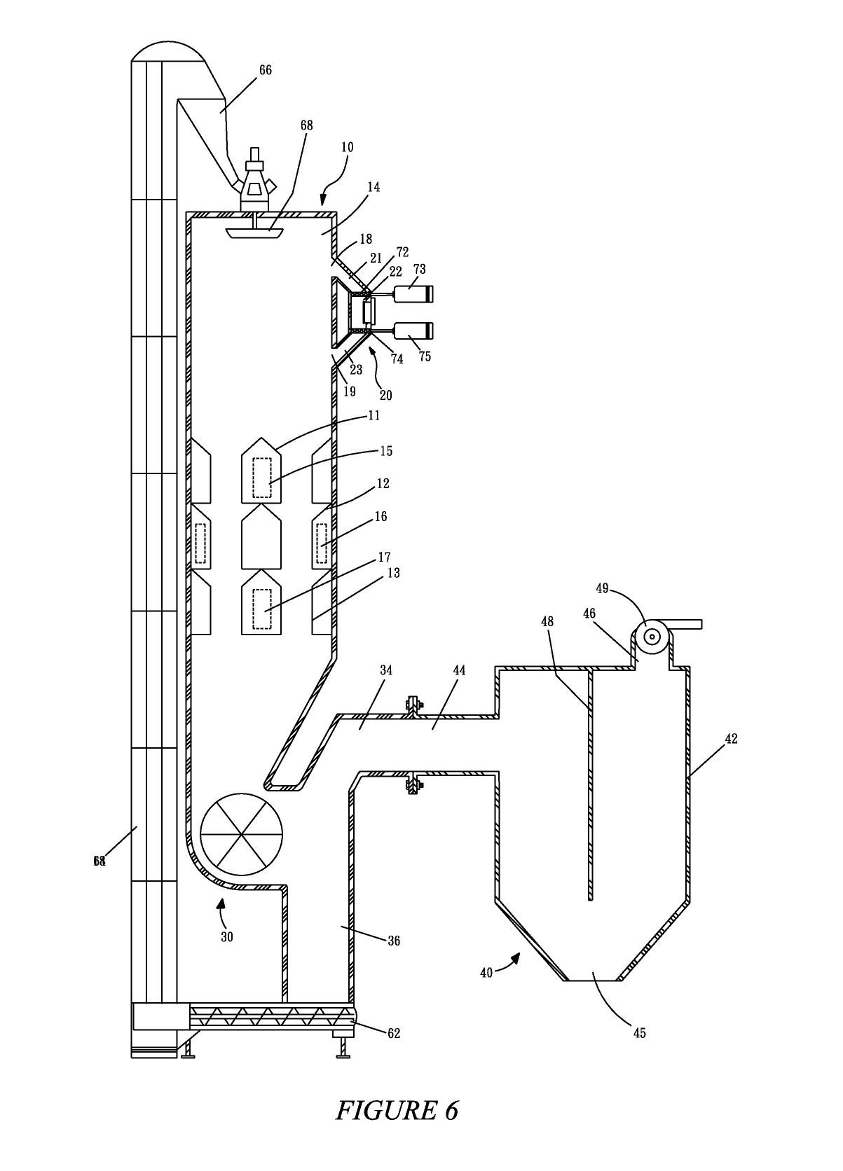

Referring to FIG. 6, the second embodiment of the uniform-heat grain dryer according to the present invention is illustrated. The bypass moisture test section 20 in the second embodiment is disposed outside the dryer section 10, and comprises a feed conduit 21, a test conduit 22, a discharge conduit 23, a first gate 72, a second gate 74, and a moisture tester 25. The present embodiment is mostly the same as the previous embodiment; Main differences of the present embodiment from the previous embodiment are in that the first gate 72 is disposed at a preset position in the joint between the feed conduit 21 and the test conduit 22 to open or shut the joint such that it is capable of being operated to select a state of the feed conduit 21 communicating with the test conduit 22 or a state of the feed conduit 21 blocked from the test conduit 22; the first gate 72 is actuated by a first hydraulic cylinder 73. The second gate 74 is disposed at a preset position in the joint between the test conduit 22 and the discharge conduit 23 to open or shut the joint such that it is capable of being operated to select a state of either the test conduit 22 communicating with the discharge conduit 23 or the test conduit 22 blocked from the discharge conduit 23; the second gate 74 is actuated by a second hydraulic cylinder 75. When the first hydraulic cylinder 73 moves to open the first gate 72, the feed conduit 21 communicates with the test conduit 22 and the sample grains 50 in the drying chamber 14 are admitted via the first opening 18 to be tested by the moisture tester 25; after being tested, the sample grains 50 fall down to the second gate 74, and, at the same time, the second hydraulic cylinder 75 moves to open the second gate 74 such that the test conduit 22 is in a state of communicating with the discharge conduit 23; thus, the sample grains 50 are sent back to the drying chamber 14 via the discharge conduit 23 and the second opening 19.

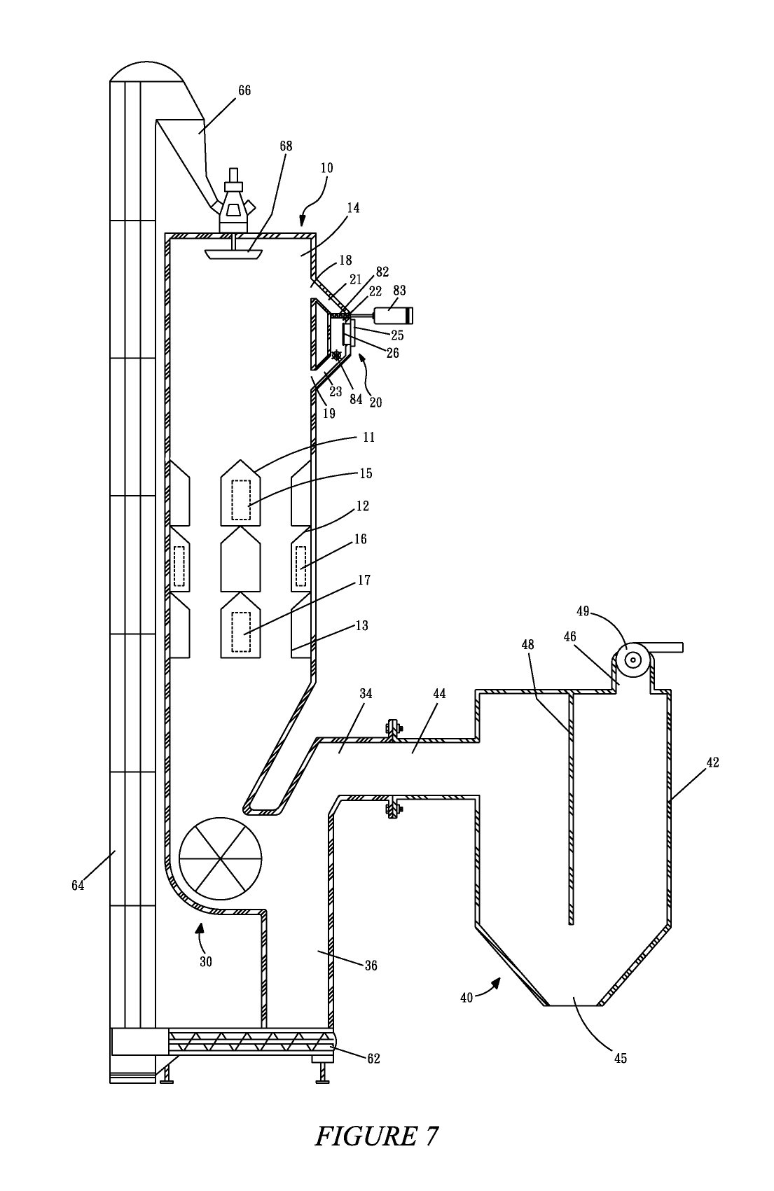

Referring to FIG. 7, the third embodiment of the uniform-heat grain dryer according to the present invention is illustrated. The bypass moisture test section 20 in the third embodiment is disposed outside the dryer section 10, and comprises a feed conduit 21, a test conduit 22, a discharge conduit 23, a feed gate 82, a delivery device 84, and a moisture tester 25. The present embodiment is mostly the same as the previous embodiments; main differences of the present embodiment from the previous embodiments are in that the feed gate 72 is disposed at a preset position in the joint between the feed conduit 21 and the test conduit 22 to perform opening or shutting the joint such that a state of either the feed conduit 21 communicating with the test conduit 22 or the feed conduit 21 blocked from the test conduit 22 can be obtained; the first gate 72 is actuated by a feed hydraulic cylinder 83. The delivery device 84 is disposed at a preset position in the joint between the test conduit 22 and the discharge conduit 23, and it can be a delivery roller driven by a motor (not shown). When the feed hydraulic cylinder 83 moves to open the feed gate 82, the feed conduit 21 communicates with the test conduit 22, and the sample grains 50 in the drying chamber 14 are admitted via the first opening 18 to be tested by the moisture tester 25; after being tested, the sample grains 50 are sent by the running roller of the delivery device 84 and back to the drying chamber 14 via the discharge passage 23 and the second opening 19.

While the invention has been described with referencing to preferred embodiments thereof, it is to be understood that modifications or variations may be easily made without departing from the spirit of this invention, which is defined by the appended claims.

What is claimed is:

1. A uniform-heat grain dryer with bypass moisture tester, comprising:
a dryer section, a bypass moisture test section, an impurity separating section and an impurity collecting section; wherein:
the dryer section has two openings at two preset positions of an outer side thereof, and a drying chamber with a plurality of drying units inside, the drying units each are disposed with a hot air outlet respectively to form multi-stage hot air outlets alternately located at centers and two opposite sides of the drying units with hot air blown out via the respective hot air outlet being in a direction opposite to each other;
the bypass moisture test section is positioned outside the dryer section between the two openings, and further comprises a feed conduit, a test conduit, a discharge conduit, and a moisture tester, wherein the feed conduit and the discharge conduit each has an end to connect one of the two openings respectively, and the moisture is settled at a preset position of the test conduit;
the impurity separating section has a separating drum disposed at a bottom of the dryer section, an impurity collection port disposed near top of the separating drum, a grain discharge port disposed near bottom of the separating drum; wherein the separating drum rotates to separate grains from impurities with a thin layer effect;
the impurity collecting section is settled at a downstream of the impurity separating section, and further comprises an impurity collecting barrel, an impurity input pipe, an exhaust pipe with an exhaust fan, and a baffle; wherein the impurity input pipe is disposed at a lateral side of the impurity barrel, the exhaust pipe with the exhaust fan is disposed at a top of the impurity barrel, the baffle is disposed in the impurity barrel, and the impurity barrel has a bottom opening to collect the impurities obtained with the thin layer effect;
whereby, when the grains are poured into the dryer section from the top thereof, the grains are dried in the dryer section alternately with multi-stage hot air outlets, a small amount of the grains is taken as sample grains to be tested moisture therein with the bypass moisture test section, the dried grains are separated from the impurities with thin layer separation done by the impurity separating section, and the impurities are collected with sedimentary collection done by the impurity correcting section.

2. The uniform-heat grain dryer with bypass moisture tester as defined in claim 1, wherein the multi-stage hot air outlets have a first stage hot air outlet, a second stage hot air outlet, a third stage hot air outlet, and so on; the hot air blown via the first stage hot air outlet is in a direction opposite to that blown via the second stage hot air outlet, the hot air blown via the second stage hot air outlet is in a direction opposite to that blown via the third stage hot air outlet, and so on.

3. The uniform-heat grain dryer with bypass moisture tester as defined in claim 2, wherein the hot air blown via the first stage hot air outlet moves toward two sides from a center thereof; the hot air blown via the second stage hot air outlet moves toward a center from two sides thereof; the hot air blown via the third stage hot air outlet moves toward two sides from a center thereof, and so on.

4. The uniform-heat grain dryer with bypass moisture tester as defined in claim 1, wherein the separating drum rotates clockwise with a centrifugal force; the grains, which are heavier than the impurities, are slung downward and the impurities are slung upward by the centrifugal force.

5. The uniform-heat grain dryer with bypass moisture tester as defined in claim 1, wherein the impurity input pipe of the impurity collecting section is connected and engaged to the impurity collection port with fasteners.

6. The uniform-heat grain dryer with bypass moisture tester as defined in claim 1, wherein the baffle blocks the impurities moving forward, and the blocked impurities fall down to the bottom opening along the baffle.

7. The uniform-heat grain dryer with bypass moisture tester as defined in claim 1, wherein the grains discharge via the grain discharge port, are delivered to the top of the dryer section with a grain conveying device and a lifting device next to the dryer section, reach the grain scattering device via a duct, and are sprinkled downward from top of the drying chamber.

8. The uniform-heat grain dryer with bypass moisture tester as defined in claim 1, wherein a rotating roller is disposed at a preset position in a joint between the test conduit and the discharge conduit as a conveying device.

9. The uniform-heat grain dryer with bypass moisture tester as defined in claim 1, wherein a first gate is disposed at a preset position in a joint between the feed conduit and the test conduit, and a second gate is disposed at a preset position in a joint between the test conduit and the discharge conduit; the first and second gates are selected to be open or shut.

10. The uniform-heat grain dryer with bypass moisture tester as defined in claim 1, wherein a feed gate is disposed at a preset position in a joint between the feed conduit and the test conduit and is selected to be open or shut; a rotating roller is disposed at a preset position in a joint between the test conduit and the discharge conduit as a conveying device.

11. The uniform-heat grain dryer with bypass moisture tester as defined in claim 1, wherein the moisture tester has a testing surface made of glass.
